(19) United States
(12) Patent Application Publication
(10) Pub. No.: US 2004/0251301 A1
(43) Pub. Date: Dec. 16, 2004

(54) Device for calculating anticipated days for menstruation

(76) Inventors: Amy C. Niemann, Point Pleasant, NJ (US); Carol A. Nuttle, Sparta, NJ (US); Mary P. Beriont, Garwood, NJ (US); Jeffrey H. Glaser, Hillsborough, NJ (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/428,803

(22) Filed: May 5, 2003

(51) Int. Cl. G06C 27/00

(52) U.S. Cl. 235/77

(57) ABSTRACT

The present invention is a menstrual cycle calculation device, including a calendar, which has a time period spanning more than two months displayed thereon. The device includes a first date indicator movable with respect to the calendar to identify a first date on the calendar. This first date corresponds to a first day for taking a first cycle of an oral contraceptive regimen. The device also includes at least one range indicator that moves in a corresponding manner with the first date indicator to show a range between two dates on the calendar. This range corresponds to days wherein a menstrual period is expected. The present invention also is directed towards a method for calculating dates of menstrual cycles several months in advance using such a device.

### BACKGROUND OF THE INVENTION

1. Field of the Invention

The present invention is directed towards a device for calculating expected dates of menstruation several months in advance for a woman taking certain oral contraceptives.

2. Related Art

Many calculation methods are known in the art for determining the dates for subsequent menstrual periods based on the date of a first period. For example, U.S. Pat. No. 3,279,696, is directed towards a dial calculator for predicting a subsequent first day of a menstrual cycle based on the first date of a previous menstrual cycle. Some women have very regular menstrual cycles, such that it is particularly easy to predict the date based on a woman's past cycles. Nonetheless, it is nearly impossible to calculate farther than one month in advance because even women with regular cycles may begin one or more days early or late. One or two days off from the last month's calculation can alter the calculation for subsequent months.

Women who are taking a conventional oral contraceptive regimen should have regular 28-day menstrual cycles. In a conventional oral contraceptive regimen, a patient takes a progestin hormone or a combination of progestin and estrogen hormones for 21 days consecutively. Between the 22^{nd} day and the 28^{th} day, she takes no hormones, or she may take a placebo. On the 29^{th} day, the patient begins another 21 days cycle of hormones. In this regimen, the patient typically menstruates during the 22^{nd} and 28^{th} day, usually with great regularity as her body becomes used to several months of taking the hormones on a 28-day cycle. Physicians initially used a 28-day cycle to mimic the natural 28-day cycle and to confirm with a regular menstrual period whether or not a patient may be pregnant.

Recently, studies have shown no physiological reason that women need to menstruate every 28-days. In fact, many women benefit from an oral contraceptive regimen in which they menstruate less often, particularly women who have severe cramping, premenstrual syndrome or other undesirable effects from menstruation or a change in hormonal administration. Other women prefer the convenience of menstruating less often. Since there appears to be no health detriment, a new regimen has been developed in which a patient takes an oral contraceptive, with no placebo, consecutively over several months. In this regimen, the patient does not have a menstrual cycle every 28-days, but can put off the hassle and much of the other negative aspects of having a menstrual period for several months.

Thus, it is desirable to have a tool or device for calculating dates for anticipating menstruation several months in advance for a woman using an oral contraceptive regimen other than a 28-day conventional oral contraceptive regimen.

### BRIEF SUMMARY OF THE INVENTION

The present invention is directed to a menstrual cycle calculation device. This device includes a calendar, having a time period spanning more than two months displayed thereon. The device also includes a first date indicator. The first indicator is movable with respect to the calendar to identify a first date on the calendar. The first date indicator corresponds to a first day for taking a first cycle of an oral contraceptive regimen, or the date of the first oral contraceptive dose. The device also includes at least one range indicator. The range indicator is positioned to move in relation to or in conjunction with the first date indicator to signify a range between two dates on the calendar. In other words, the range indicator is configured to identify a date range based on the first date indicator. This range corresponds to days wherein placebos or at least no hormones are taken during the time period identified on the calendar by the range indicator. The range indicator shows the dates on which menstruation may be anticipated.

The device may also include a second date indicator. The second date indicator is also positioned to move in relation to or in conjunction with the first date indicator to identify a second date on the calendar. The second date indicator corresponds to a day for beginning a second cycle of the oral contraceptive regimen.

The device may be a dial calculator. The dial calculator may include a first circular disk upon which the calendar is printed and a second circular disk upon which the first date indicator, the at least one range indicator and the second date indicator are printed. The first disk and the second disks mutually rotate with respect to each other by a connection located at a center point of the first disk and a center point of the second disk. Aligning the first date indicator on the second disk with a first date on the calendar of the first disk automatically aligns the range indicator between two dates on the calendar and the second date indicator with a second date on the calendar.

One of the first disk and the second disk may be a larger disk, which has a larger diameter. The other disk is a smaller disk, which has a smaller diameter. Information displayed on an outer margin of the larger disk is easily aligned with information displayed on an outer margin of the smaller disk.

Preferably, the larger disk is the first disk.

In another embodiment, one of the first disk or the second disk may be made of a transparent material. The other disk may be made of an opaque material. Information printed on the opaque disk may be read through the transparent disk.

In another embodiment, one or more of the first date indicator, the at least one range indicator or the second date indicator is a cut-out window in the second disk. At least a portion of the calendar of the first disk is visible through the cut-out window.

Alternatively, the device may be a slide rule. The calendar may be printed on a first rule, and the first date indicator, the at least one range indicator and the second date indicator may be printed on a second rule. The first rule is slidably aligned with the second rule.

The device may also have the calendar printed on a first cylinder having a first diameter. First date indicator, the at least one range indicator and the second date indicator are printed on a coaxial second cylinder having a second diameter that is different than the first diameter. One of the first cylinder or the second cylinder is slidably inserted inside the other.

Preferably, the calendar of the device is a 12-month calendar. In this preferred embodiment, it is likely that the device comprises more than one range indicator.

The device may have a front side on which the elements thereof are positioned or printed and a back side that is not used to calculate menstrual dates. Instructions for use of the device and an identifying means may be placed on the back side.

In yet another embodiment, the device may comprise only a calendar, a first date indicator and a second date indicator. The second date indicator is positioned to move in relation to or in conjunction with the first date indicator to identify a second date on the calendar, whereby the second date corresponds to a first day for beginning a second cycle of the oral contraceptive regimen.

Another aspect of the present invention is a method for calculating menstruation dates several months in advance, including providing a calculating device having a calendar, a first date indicator and at least one range indicator. The at least one range indicator is configured to identify the dates of expected menstruation based on the first date indicator. The method includes moving the first date indicator to a position that corresponds with a day on the calendar that is a first day for starting a cycle of an oral contraceptive regimen and identifying the days on the calendar that correspond with the at least one range indicator to find expected days for menstruation.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art or arts based on the teachings contained herein.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a front plan view of a first disk of a dial calculator embodiment of the present invention.

FIG. 2 is a front plan view of a second disk of a dial calculator embodiment of the present invention.

FIG. 3 is a front plan view of a dial calculator embodiment of the present invention incorporating the disks of FIGS. 1 and 2.

FIG. 4 is a back plan view of the first disk of FIG. 1.

FIG. 5 is a front plan view of a first disk of another dial calculator embodiment.

FIG. 6 is a front plan view of a second disk of another dial calculator embodiment.

FIG. 7 is a front plan view of another dial calculator embodiment of the present invention incorporating the disks of FIGS. 5 and 6.

FIG. 8 is a plan view of a slide rule embodiment of the present invention.

FIG. 9 is a plan view of a sliding cylinder embodiment of the present invention.

The present invention will be described with reference to the accompanying drawings. The drawing in which an element first appears is typically indicated by the leftmost digit in the corresponding reference number.

### DETAILED DESCRIPTION OF THE INVENTION

The present invention is directed towards a device for calculating the days when a patient taking an oral contraceptive for an extended period of time is expected to have a menstrual period.

The device is particularly designed for women who are taking oral contraceptives for longer than the typical 28-day cycle. In particular, the device is designed for use with an oral contraceptive regimen in which the oral contraceptive is taken for twelve-weeks (84 days), then a placebo, no hormones, or a pill containing another or a different active ingredient is taken for one-week (7 days), then another twelve-week cycle of the oral contraceptive regimen begins. A woman taking this regimen typically has a menstrual period during the seven days when she is not taking the active ingredients or hormones of the oral contraceptive. Thus, she has a menstrual period every thirteen weeks, or about four times a year, rather than twelve times a year as with a conventional 28-day oral contraceptive regimen. The device of the present invention helps a user calculate the dates when menstruation may be expected several months or years in advance.

The device of the present invention is suitable for a variety of different regimens in which consecutive oral contraceptive dosages are taken for longer than 28-days. For example, a regimen in which a patient takes oral contraceptives for 6 weeks, 36 weeks, or one year are all an appropriate regimen for using a device of the present invention. The device of the present invention may be easily adapted for any oral contraceptive regimen longer than the conventional 28-day regimen. The examples discussed herein are directed towards the preferred twelve-week oral contraceptive regimen. However, one skilled in the art can appreciate the ease in adapting the various devices described herein to accommodate other oral contraceptive regimens.

It should be noted that the device of the present invention may be used with extended contraceptive regimens other than orally administered contraceptives. For example, the device may be used to calculate expected dates of menstruation associated with extended-regimen contraceptive rings, patches, injections or implants.

Generally, the invention is directed towards a device to calculate the dates when a menstrual cycle is expected to occur based on the first day of taking an oral contraceptive. The first day may be an initial introduction to the oral contraceptive regimen or may be simply the first dosage cycle started in the time period encompassed by the device. In general, a device of the present invention includes a calendar, a first date indicator and at least one range indicator or at least one second date indicator.

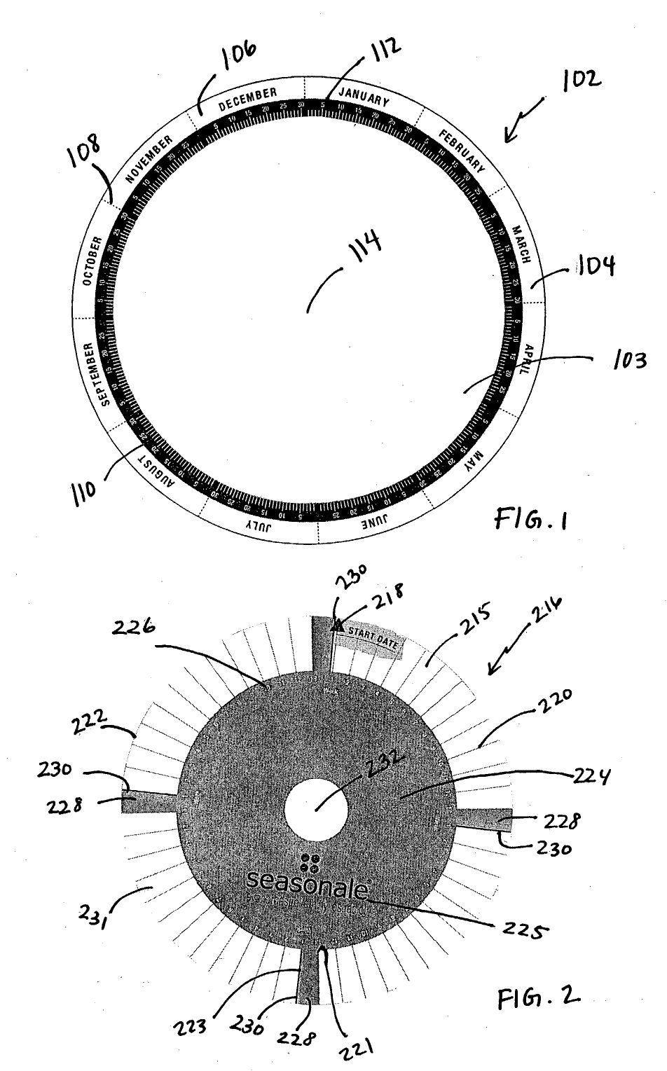

FIGS. 1 and 2 show the components of a dial calculator embodiment of the present invention. FIG. 1 shows a first side 103 of first circular disk 102. First circular disk 102 has a calendar 104 printed thereon around a circumferential margin of the disk. In the embodiment of FIG. 1, calendar 104 comprises an outer ring 106 and an inner ring 110. Outer ring 106 lists the months of the year separated by lines 108. Lines 108 distinguish where a month begins and ends. Inner ring 110 has a background of a different color from the background of outer ring 106. It also has the days of each month ticked off around the ring. Every fifth day 112 is labeled and distinguished by a larger tick. Lines 108 continue into inner ring 110 to show where each month begins and ends. First circular disk 102 is devoid of matter between inner ring 110 and the center 114 of first circular disk 102.

In FIG. 1, calendar 104 is a yearly calendar. However, the time period of calendar 104 may be longer or shorter, as desired. For example, calendar 104 may span six months, or four years, or any other time period that is appropriate based on the particular oral contraceptive regimen. For example, an oral contraceptive regimen may be developed that is taken for two months consecutively, six months consecutively or an entire year consecutively. Thus, one skilled in the relevant art can appreciate that calendar 104 can take on a variety of time periods, by varying the spacing of the days and months in calendar 104 and varying the size of disk 102. Nonetheless, any oral contraceptive regimen other than conventional 28-day regimens will likely require a time period greater than two months.

Calendar 104 also does not have to appear in the manner shown in FIG. 1. For example, calendar 104 may list the days of each month in a table format. Calendar 104 may also have a means for adapting the month of February to account for a leap year. Inner ring 110 may be switched with outer ring 106 such that the days are printed to the outside of the months. One skilled in the relevant art can appreciate a variety of calendar appearances suitable to a device of the present invention.

FIG. 2 shows a front side 215 of a second circular disk 216. Second disk 216 has a smaller diameter than first disk 102 and includes the indicators of the invention that work in conjunction with calendar 104. Second disk 216 has a first date indicator 218. First date indicator 218, in FIG. 2, is an arrowhead with a line drawn to it that is labeled “start date.” First date indicator 218 is used to indicate the first date that a new oral contraceptive cycle starts. One skilled in the relevant art can appreciate there being other ways to indicate a first date, such as a line, color highlighting or any other mark to distinguish or highlight one day on calendar 104. Another example of a first date indicator is discussed below with respect to FIG. 6.

Second disk 216 also has evenly spaced week lines 220 projecting inwardly from a circumference 222 of second disk 216. The week lines 220 extend to inner circle 224, which includes an identifying means 225, such as a logo or trademark associated with the particular oral contraceptive for which the device is to be used, and numbers 226 counting off consecutive thirteen-weeks. Second disk 216 also has range indicators 228, which are colored shaded areas between the thirteenth week line 221 and the next consecutive first week line 223. Second disk 216 also has a second date indicator 230. Second date indicator 230 is a darker or different colored line. Generally, second date indicator 230 will be the same as first week line 223, as seen in FIG. 2. Second date indicator 230 shows where the next consecutive oral contraceptive cycle begins. Second disk 216 is also devoid of matter at center 232 of second disk 216.

Preferably, start date indicator 218, range indicators 228 and second date indicators 230 are each a different color and a different color from background 231 and week lines 220.

FIG. 3 shows how first disk 102 and second disk 216 are used together. First disk 102 is connected to second disk 216, such that the front side 103 of first disk 102 and the front side 215 of second disk 216, as shown in FIGS. 1 and 2, face the same direction. In other words, the front side 103 of first disk 102 faces the back side (not shown) of second disk 216. First disk 102 and second disk 216 are connected at a center 114 of first disk 102 and center 232 of second disk 216, preferably via a brad or pin (not shown) such that second disk 216 can rotate about the center connection in a clockwise or counter clockwise direction. First date indicator 218, week lines 220, range indicators 228 and second date indicators 230 are rotated and aligned with certain dates on calendar 104.

A variety of first disks 102 and second disks 216 are suitable for use in the present invention, provided that first disk 102 and second disk 216 are compatible together. For example, calendar 104 may be thicker or thinner, but the diameter of second disk 216 will likely need to be adapted so that the indicators remained aligned therewith.

Device 301 operates as follows. Second disk 216 is rotated such that first date indicator 218 aligns with the first date that a new oral contraceptive cycle is started. With the first date indicator in place, a patient can read off the dates when a menstrual period is anticipated by seeing where range indicators 228 align with calendar 104. Also, the patient can anticipate the date when she should start the next oral contraceptive cycle of the regimen by reading the dates off calendar 104 highlighted or identified by second date indicators 230.

For example, if the first start date is December 31, as shown in FIG. 1, the patient can expect a menstrual period to occur between March 25 and April 1. A new oral contraceptive cycle is then to commence on April 1, such that a second menstrual period should occur between June 24 and July 1.

Another new oral contraceptive cycle starts on July 1, and a menstrual period should occur between September 24 and September 30. On September 30, a new cycle begins and a menstrual period is expected to occur between December 23 and December 30.

The advantage of this system is that one can plan the year in advance to know which days of an entire year to expect to menstruate. Thus, vacation plans or other important occasions may be planned accordingly several months to a year in advance.

Preferably, first disk 102 and second disk 216 are made of heavy paper stock. The information shown in FIGS. 1 and 2, respectively, is printed thereon with conventional printing methods. Alternatively, either of first disk 102 or second disk 216 may be printed on a thin transparent thermoplastic material or laminate, while the other of first disk 102 or second disk 216 is printed on an opaque material. In this embodiment, second disk 216 may have an equal or even larger diameter than first disk 102, such that the information printed on the transparent disk will overlap the information printed on an opaque disk. Thus, the important days on calendar 104 are covered or highlighted in a different color, instead of merely being pointing to as seen in FIG. 3.

FIGS. 1, 2 and 3 show calendar 104 being printed on a first disk 102 which has a larger diameter than second disk 216. Alternatively, calendar 104 may be printed on a smaller disk, while first date indicator 218, range indicators 228 and second date indicators 230 may be printed on a larger disk. The operation is the same as that for the embodiment of FIG. 3 by matching indicators to the days on the calendar. Thus, a variety of possible devices are contemplated by the present invention.

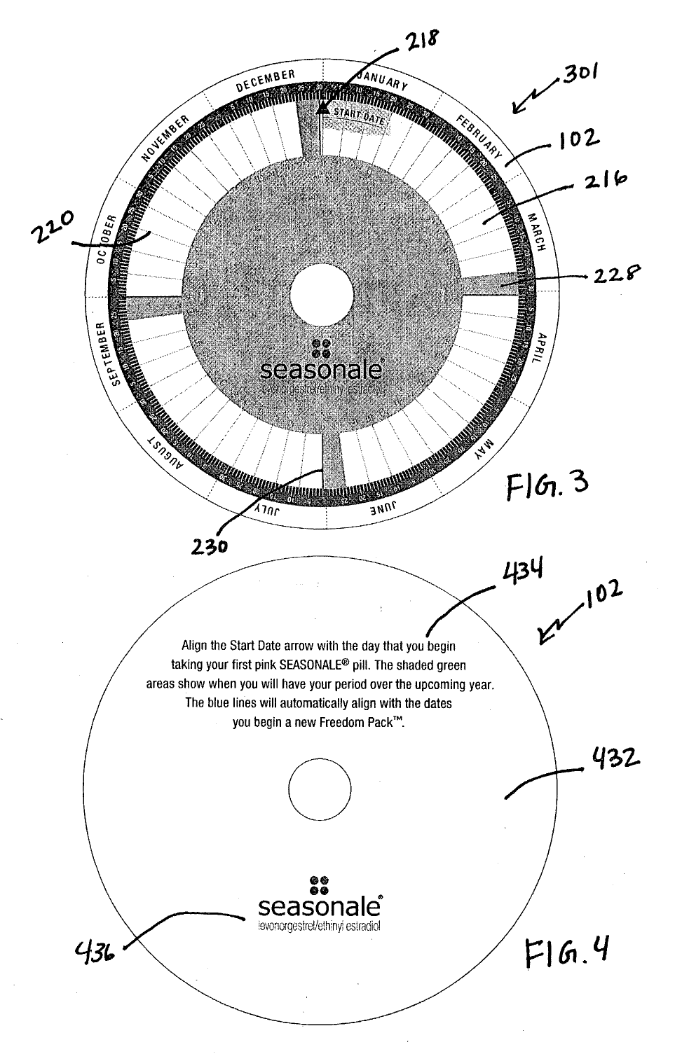

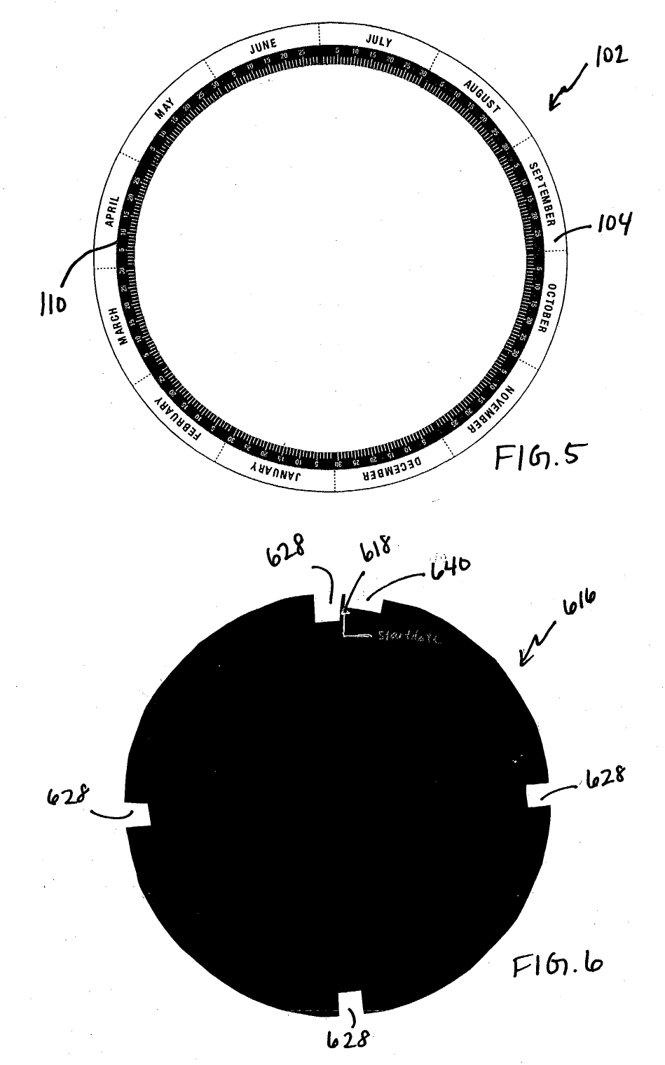

FIG. 4 shows one option for a back side 432 of first disk 102. Since back side 432 is not used for calculation, it is suitable to print instructions for use 434 and an identifying means 436 to identify or distinguish the oral contraceptive for which the device is appropriate. The identifying means 436 is preferably a logo or trademark associated with the oral contraceptive and is preferably prominently placed thereon. Alternatively, one or more additional disks (not shown) having a smaller diameter than first disk 102 may be connected to back side 432, so that device 301 may be used for other purposes. For example, device 301 may include a menstrual period calculator as previously described on the front side 103 of first disk 102, as seen for example in FIG. 3, and a device for calculating infant gestation information or for determining dates of ovulation on the back side 432. Thus, an obstetrician-gynecologist need only carry and reference one device 301 to provide more than one piece of information, depending upon what information a particular patient may need.

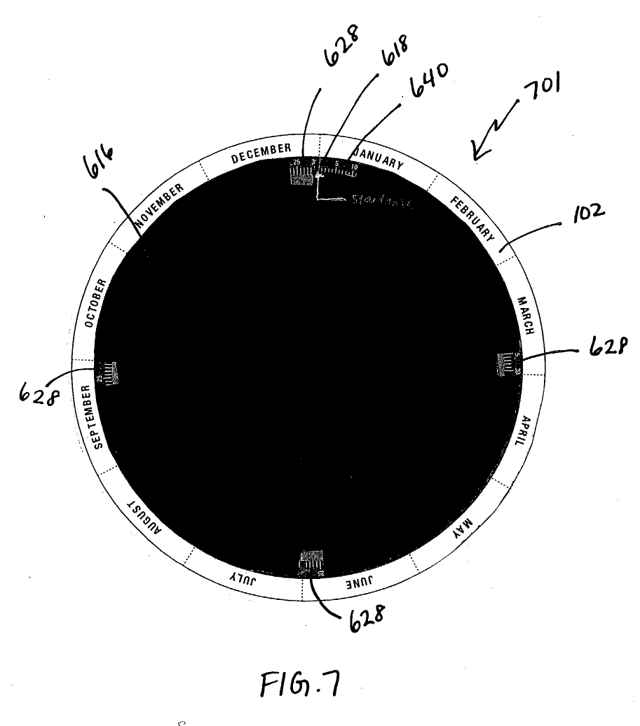

FIGS. 5 and 6 show a first disk 102 and a second disk 616 of an alternative dial calculator device of the present invention. First disk 102 is identical to first disk 102 of FIG. 1. One skilled in the art can appreciate that any of the variations suitable for first disk 102 of FIG. 1 are also suitable for first disk 102 of FIG. 5. Thus, the embodiment of FIGS. 5 and 6 also utilize a calendar 104.

FIG. 6 shows an alternative second disk 616. Second disk 616 has a smaller diameter than first disk 102, such that its diameter is about the same as that of inner ring 110 of first disk 102. Second disk 616 has a first date indicator 618 and range indicators 628. Both first date indicator 618 and range indicators 628 use cut-out windows. In addition, second disk 616 may have a second date indicator (not shown), akin to second date indicator 230, by including a line to the right of each range indicator 628 to show that the last date for expecting a menstrual period is the day in which a new oral contraceptive cycle begins.

First date indicator 618 has a large cut-out window 640. First date indicator 618 is properly aligned with only one day, but calendar 104 of FIG. 5 has every fifth day labeled. Therefore, cut-out window 640 is large enough to show at least one reference day near the actual start date to let the user know that the start date is properly aligned with the arrowhead of first date indicator 618.

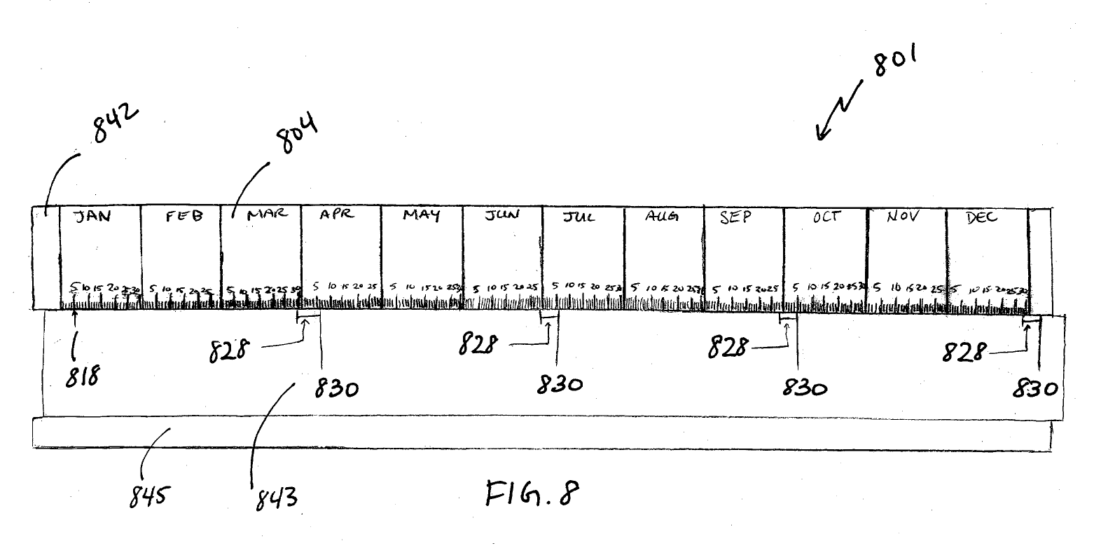

FIG. 7 shows device 701 incorporating first disk 102 and second disk 616 as aligned with each other. First disk 102 and second disk 616 are connected by a pin or brad (not shown) such that second disk 616 may be rotated clockwise or counter clockwise with respect to first disk 102. Range indicators 628 show the dates when a menstrual period may be anticipated through cut-out windows. The embodiment of FIG. 7 also has the first date starting on December 31. Consequently, the range indicators have the same range dates as that of the embodiment shown in FIG. 3.

Alternatively, device 701 may have second disk 616 with a diameter larger than or equal to first disk 102. In this embodiment, window 640 and range indicators 628 are not cut-out from the circumference of second disk 616, but are holes cut into second disk 616 through which calendar dates are viewed. Further, another window may be available in second disk 616 to view a month designation of calendar 104. One skilled in the art can appreciate that there are a variety of devices 701 having cut-out windows that are suitable for the present invention, particularly considering the variety of calendars 104 that may be used.

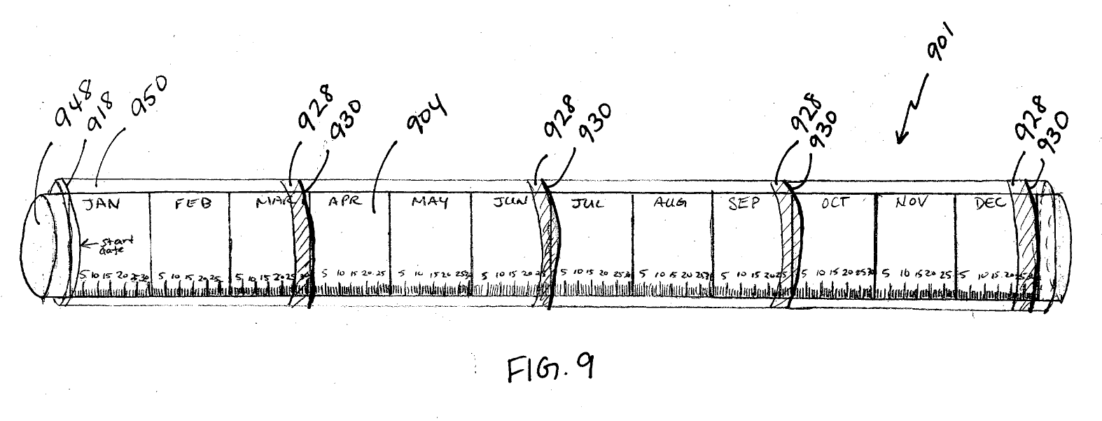

FIG. 8 is another embodiment of the present invention. FIG. 8 shows device 801 in the form of a slide rule. Device 801 includes a first rule 842.

First rule 842 comprises a calendar 804. Calendar 804 is a linear calendar in which the days of the year are equally spaced along first rule 842. Calendar 804 is similar to calendar 104 of FIG. 1 in that it has a tick for each day of the year with every fifth tick being longer and labeled. One skilled in the art can appreciate that a variety of calendars are suitable in the present invention and that the scope of the invention is not limited to those shown in this embodiment. For example, calendar 804 may define a time period of several months to several years.

Device 801 also comprises a second rule 843. Second rule 843 is slidable along first rule 842. Optionally, device 843 has a bank 845 permanently attached to first rule 843 for keeping second rule 843 next to but slidable against first rule 842. Second rule 843 comprises a first date indicator 818 consisting of an arrow. Second rule 843 also has range indicators 828 and second date indicators 830.

Device 801 is operated in the following manner. Second rule 843 slides along 842 until first date indicator 818 is aligned with the day of the first oral contraceptive cycle, i.e., the date that a first pill is taken. For example, in FIG. 8, the first date indicator is aligned with January 5. From the positioning of first date indicator 818, days of anticipated menstruation are determined from the alignment of range indicators 828. For example, in FIG. 8, anticipated dates of menstruation include March 30 to April 6, June 29 to July 6, September 28 to October 5, and December 28 to seven days after December 28, or January 4.

Obviously, the advantage of having a dial calculator as shown in FIGS. 3 and 7 is that the calendar is perpetual. One or more range indicators 828 of the embodiment shown in FIG. 8 will fall off of calendar 804. Thus, this date has to be calculated by the individual. To solve this problem, calendar 804 may be extended to include a longer time period. For example, if the calendar is extended for two full years and if the first cycle starts on December 1, the range indicators 828 will always hit a day of the calendar. Preferably, however, calendar 804 is extended only far enough that at least one range indicator 828 and one second date indicator 830 may be placed on the calendar if the first date indicator 818 is placed on the last day of the year. In the present example, the calendar 804 need only be extended until April 1. Thus, if the start date is December 31, the second date indicator 830 shows that the second cycle starts April 1. The device 801 can then be reset using April 1 as the start date to find additional dates for menstruation throughout the year.

FIG. 9 shows another embodiment of the present invention. Device 901 has a first cylinder 948 and a second cylinder 950. First cylinder 948 comprises calendar 904 printed thereon. Calendar 904 is very similar to calendar 804 in FIG. 8 in that they are both linear and have similar day and month designations. One skilled in the art can appreciate that a variety of calendars may be suitable in the present invention.

Second cylinder 950 has a larger diameter than first cylinder 948. They are coaxially aligned, such that first cylinder 948 is inserted inside second cylinder 950. Second cylinder 950 comprises a first date indicator 918, which is a line running around the circumference of second cylinder 950. Second cylinder 950 also includes range indicators 928 and second date indicators 930. Range indicators 928 are shown in FIG. 9 as wider bands running around the circumference of second cylinder 950. Second cylinder 950 is preferably made from a transparent material, such as a thermoplastic polymer. Thus range indicators 928 may be colored transparent bands, such that a user can read through second cylinder 950 to view the days on calendar 904 highlighted by range indicators 928. Alternatively, second cylinder 950 may be opaque, such that range indicators 928 are cut-out windows in second cylinder 950. Second date indicators 930 are also lines drawn around the circumference of second cylinder 950.

In an alternative embodiment, first cylinder 948 may have a larger diameter than second cylinder 950. Second cylinder 950 may fit inside first cylinder 948 in coaxial alignment. In this embodiment, calendar 904 may be printed on a transparent material such that the calendar dates may be aligned with first date indicator 918, range indicators 928 and second date indicator 930, which are visible throughout.

While various embodiments of the present invention have been described above, it should be understood that they have been presented by way of example only, and not limitation. It will be apparent to persons skilled in the relevant art that various changes in form and detail may be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A menstrual cycle calculation device, comprising:
a calendar, said calendar having a time period spanning more than two months displayed thereon;
a first date indicator, wherein said first indicator is movable with respect to said calendar to identify a first date on said calendar, such that said first date corresponds to a first day for taking a first cycle of an oral contraceptive regimen; and
at least one range indicator, wherein said range indicator is positioned to move in relation to said first date indicator to show a range between two dates on said calendar, whereby said range corresponds to days wherein a menstrual period is anticipated.

2. The device of claim 1, further comprising a second date indicator, wherein said second date indicator is positioned to move in relation to said first date indicator to identify a second date on said calendar, whereby said second date corresponds to a first day for beginning a second cycle of said oral contraceptive.

3. The device of claim 2, wherein said device is a dial calculator, said dial calculator including
a first circular disk upon which said calendar is printed; and
a second circular disk upon which said first date indicator, said at least one range indicator and said second date indicator are positioned,
wherein said first disk and said second disks mutually rotate with respect to each other by a connection located at a center point of said first circular disk and a center point of said second circular disk, such that aligning said first date indicator on said second circular disk with a first date on said calendar of said first circular disk automatically aligns said range indicator with said range between two dates on said calendar and said second date indicator with said second date on said calendar.

4. The device of claim 3, wherein one of said first circular disk and said second circular disk is a larger disk which has a larger diameter than the other which is a smaller disk, so that information displayed on an outer margin of said larger disk aligns with information displayed on an outer margin of said smaller disk.

5. The device of claim 4, wherein said larger disk is said first circular disk.

6. The device of claim 3, wherein one of said first or second circular disks is a transparent disk made of a transparent material and the other disk is an opaque disk made of an opaque material, wherein information printed on said opaque disk is visible through said transparent disk.

7. The device of claim 3, wherein at least one of said first date indicator, said at least one range indicator or said second date indicator is a cut-out window in said second disk and at least a portion of said calendar is visible through said window.

8. The device of claim 1, wherein said device is a slide rule, having said calendar on a first rule and said first date indicator, said at least one range indicator and said second date indicator on a second rule, and said first rule is slidably aligned with said second rule.

9. The device of claim 1, wherein said calendar is printed on a first cylinder having a first diameter and said first date indicator and said at least one range indicator is printed on a coaxial second cylinder having a second diameter that is different than said first diameter and wherein one of said first cylinder and said second cylinder is slidably inserted inside the other.

10. The device of claim 1, wherein said calendar is a 12-month calendar.

11. The device of claim 10, wherein said device comprises more than one range indicator.

12. The device of claim 1, wherein said device further comprises a front side and a back side, said back side having instructions for use and an identifying means printed thereon.

13. A menstrual cycle calculation device, comprising:
a calendar, said calendar having more than two months displayed thereon;
a first indicator, wherein said first indicator is movable to identify a first date on said calendar and wherein said first date corresponds to the first day for taking an oral contraceptive dose; and
at least one second indicator, wherein said second indicator is configured to identify a date range based on said first date indicator and wherein said date range corresponds to expected days for menstruation.

14. A menstrual cycle calculation device, comprising:
a calendar, said calendar having a time period spanning more than two months displayed thereon;
a first date indicator, wherein said first indicator is movable to identify a first date on said calendar and wherein said first date corresponds to a first day for taking a first cycle of an oral contraceptive regimen; and
a second date indicator, wherein said second date indicator is positioned to move in relation to said first date indicator to identify a second date on said calendar, whereby said second date corresponds to a first day for beginning a second cycle of said oral contraceptive regimen.

15. A method for calculating menstruation dates several months in advance, comprising:
providing a calculating device having a calendar, a first date indicator and at least one range indicator, wherein said at least one range indicator is configured to identify the dates of expected menstruation based on said first date indicator;
moving said first date indicator to correspond with a day on said calendar that is a first day for starting an oral contraceptive cycle; and
reading the days on said calendar that correspond with said at least one range indicator to find expected days for menstruation.
